(19) United States
(12) Patent Application Publication
(10) Pub. No.: US 2026/0021624 A1
(43) Pub. Date: Jan. 22, 2026

(54) PRESSURE-MOLDING APPARATUS AND METHOD FOR CARRYING OUT A THERMOFORMING OPERATION

(71) Applicant: SCHEU-DENTAL GMBH, Iserhohn (DE)

(72) Inventors: Yong-min JO, Duesseldorf (DE); Andrea Pascadopoli, Dortmund (DE); Ralf Kalthaus, Hagen (DE)

(21) Appl. No.: 19/288,821

(22) Filed: Aug. 1, 2025

Related U.S. Application Data
(63) Continuation of application No. PCT/EP2024/055813, filed on Mar. 6, 2024.

(30) Foreign Application Priority Data
Mar. 13, 2023 (DE) 10 2023 106 142.9

(51) Int. Cl. B29C 51/08; A61C 7/08; B29C 51/26; B29C 51/46; B29L 31/00

(52) U.S. Cl. CPC B29C 51/08; A61C 7/08; B29C 51/261; B29C 51/46; B29L 2031/753

(57) ABSTRACT

A pressure forming device for dental deep drawing applications, including a housing; a foil carrier configured to support a deep drawing foil; at least one operating unit at least partially arranged in the housing and including a heating device configured to heat the deep drawing foil to a deep drawing temperature; a model carrier, configured to support a jaw model; and a pressure device, configured to provide a pneumatic pressure, wherein the pressure device is configured to cooperate with the deep drawing foil and the model carrier when performing a deep drawing process, so that the deep drawing foil, after performing a heating step of the deep drawing process in which the deep drawing foil heated by the heating device, is loaded with pneumatic pressure in a forming step of the deep drawing process and thus deep drawn over the jaw model supported on the model carriers.

### RELATED APPLICATIONS

This application is a continuation of international patent application PCT/EP2024/055813, filed on Mar. 6, 2024, claiming priority from German patent application DE 10 2023 106 142.9, filed on Mar. 13, 2023, both of which are incorporated in their entirety by this reference.

### FIELD OF THE INVENTION

The instant application relates to a pressure forming device in the field of dental deep drawing according to the preamble of claim 1. The instant application furthermore relates to a deep drawing method according to the preamble of claim 11.

### BACKGROUND OF THE INVENTION

Using a deep drawing device for dental deep drawing is used, in particular, for dental braces designated as aligners. The aligners are used in orthodontal treatments for actively moving or passively retaining teeth of a respective patient and are thus used for correcting or preventing dental misalignments.

Pressure forming devices are known in the art, and references are made to the product Biostar by the applicant. Pressure forming devices are accordingly known from the manufacturer's Erkodent, Erick Kopp, e.g. in the form of “Erkopress 240”, or Dreve Dentamid, e.g. in the form of Vacfomat V9.

All the known devices have their particular disadvantages. It is desirable, in particular, to produce active orthodontal treatment elements by dental deep drawing with moderate complexity in rather large numbers without quality reduction of the serially molded parts, compared to making a single part from a single mold. In order to achieve a high quality level, it is required, in particular, to evenly warm the respective deep drawing foil during a heating step of a deep drawing process and to be able to precisely adjust a temperature of the deep drawing foil on a side that is oriented towards the model of the jaw. This option shall exist irrespective of whether a single treatment element is produced in a single deep drawing process or multiple treatment elements are produced in multiple deep drawing processes.

The pressure forming device shown in WO 2020/10225 is intended to achieve particularly even warming of the deep drawing foil. The model and the deep drawing foil are placed on a model carrier so that the model is arranged below the deep drawing foil. The loaded model carrier is placed on a conveyer belt and moved to a second conveyor belt. A heating step and a forming step are subsequently performed along a conveying axis of the second conveyor belt. The heating step heats the deep drawing foil, supported above a model initially using a first heating device and subsequently using a second heating device, wherein the two heating devices heat the deep drawing foil from a side that is oriented away from the model. Thereafter, the model, including the heated deep drawing foil arranged there above, is transported to a pressure forming device so that the forming step can be performed. Each heating device is configured to heat an additional deep drawing foil in parallel with the forming step.

### BRIEF SUMMARY OF THE INVENTION

It is an object of the invention to provide a pressure forming device configured to perform a large number of moldings of jaw models without individual moldings suffering reduced quality.

The object is achieved by a pressure forming device for dental deep drawing applications, the pressure forming device including a housing; a foil carrier configured to support a deep drawing foil; at least one operating unit at least partially arranged in the housing and including a heating device configured to heat the deep drawing foil to a deep drawing temperature; a model carrier, configured to support a jaw model; and a pressure device, configured to provide a pneumatic pressure, wherein the pressure device is configured to cooperate with the deep drawing foil and the model carrier when performing a deep drawing process, so that the deep drawing foil, after performing a heating step of the deep drawing process in which the deep drawing foil heated by the heating device, is loaded with pneumatic pressure in a forming step of the deep drawing process and thus deep drawn over the jaw model supported on the model carriers, wherein a pressure cylinder of the pressure device and the model carrier are movable towards one another along an operating axis of the operating unit, so that the pressure device is movable into indirect or direct operating engagement with the model carrier in order to perform the forming step, wherein the heating device and the model carrier are arranged on an identical side of the deep drawing foil, wherein the heating device and the model carrier are alternatively movable by a movement device into an operating position that is arranged along the operating axis.

Advantageous embodiments can be derived from the dependent claims.

The pressure forming device includes a housing, a foil carrier configured to support at least one deep drawing foil, and at least one operating unit at least partially arranged in the housing. The operating unit includes a heating unit, a model carrier, and a pressure device. The heating device of the operating unit is configured and provided to heat the deep drawing foil supported in the foil carrier. This way, the deep drawing foil becomes flexible or soft and thus deformable, so that it can be deep drawn over a jaw model in a known manner with pressure applied. The heating device can be, for example, a silica tube radiator that includes a high-temperature heating wire and a surface coating that filters shortwave radiation. The heating device can be configured according to German patent DE 10 307 688 B4, which is incorporated in its entirety with respect to the heating device.

The jaw model, over which the deep drawing foil shall be deep drawn after performing a heating step, is supportable on the model carrier of the operating unit. The jaw model can be produced, e.g. based on a capture or a model of an upper jaw or a lower jaw of a patient, e.g. made from plaster. It is also conceivable to produce the jaw model by 3D-printing, based on a digital capture or digital modeling of an upper jaw or a lower jaw of a patient. The model carrier can advantageously include vent openings which facilitate an exit of air during a deep drawing process of a deep drawing foil through a jaw model supported on the model carrier. This way, the deep drawing foil can apply to the jaw model as intended, wherein air that is trapped between the deep drawing foil and model carrier can escape through the vent openings, which prevents a formation of air entrapments between the deep drawing foil and the jaw model. Dimensions of the model carrier are advantageously configured to receive exactly one jaw model. Thus, the model carrier can include, in particular, a circular contact surface for central application of a respective jaw model.

The pressure device of the operating unit is configured to impart pneumatic pressure upon a heated deep drawing foil, so that the deep drawing foil is applied snug to the jaw model, so that the shape of the jaw model is captured. As a matter of principle, the pressure device can be configured to generate positive pressure or negative pressure, wherein the negative pressure causes the drawing foil to be pressed against the jaw model from a side that is oriented away from the jaw model, so that the deep drawing foil is applied snug to the jaw model. When applying negative pressure, the deep drawing foil is pulled onto the jaw model from a side oriented towards the jaw model and thus applied snug and precisely to the jaw model. Both types of forming are generally designated as “deep drawing”.

At least two steps are performed in order to completely perform a deep drawing process, namely, a heating step and a forming step. These steps of the deep drawing method can be performed directly sequentially or with an interruption between the steps or by performing at least one intermediary step between the steps.

The heating step heats the deep drawing foil using the heating device so that the deep drawing foil becomes hot and is configured to be deep drawn over a respective jaw model. An assessment of whether the deep drawing foil is heated sufficiently for performing the forming step can be made using several parameters. For example, the heating device can be activated for a predetermined period of time, designated as “heating time”. It is also conceivable to monitor a surface temperature of the deep drawing foil and to terminate the heating step as a function of temperature, e.g. when the temperature of the deep drawing foil reaches a predetermined nominal value.

The forming step is performed indirectly or directly after the heating step is completed, wherein the deep drawing foil is loaded with pneumatic pressure during the deep drawing step and thus deep drawn over the jaw model supported on the model carrier.

The pressure device includes a pressure cylinder that provides the pneumatic pressure, wherein the pressure cylinder can be connected with a pressure generator, e.g. by a pressure conduit. The pressure generator can be formed, e.g. by an air compressor. The pressure cylinder and the model carrier are movable towards each other along an operating axis of the operating unit, in order to deep draw the heated deep drawing foil over the jaw model. As a consequence, the pressure device can be brought into direct or indirect operating engagement with the model carrier in order to perform the forming step. When there is an indirect engagement, the pressure device can come into direct contact with the deep drawing foil, wherein the operating engagement of the pressure device with the model carrier is generated by the deep drawing foil arranged therebetween. Thus, the pressure cylinder seals tight with a surface of the deep drawing foil, so that the deep drawing foil defines a pressure cavity formed in the pressure cylinder. Irrespective of whether an indirect or direct operating engagement between the pressure device and the deep drawing foil is provided, the deep drawing foil is deep drawn over the jaw model, since a pneumatic pressure is generated in the pressure cylinder, wherein the deep drawing foil contacts the surface of the jaw model directly as intended, so that the shape of the jaw model is captured precisely. The pressure can be provided in the form of positive pressure as well as in the form of a negative pressure.

The pressure forming device according to the invention is characterized in that the heating device as well as the model carrier are arranged on the same side of the deep drawing foil. This provides the option to heat the deep drawing foil in the heating step of the deep drawing process from a side that is deep drawn over the jaw model during the subsequent forming step of the deep drawing process, wherein the heating is provided by the heating device. This has the advantage that the deep drawing foil can be heated precisely, which assures the quality of the form capture of the respective jaw model subsequent to the forming step.

The invention is furthermore based on the idea that it is particularly useful for arranging the heating device in the model carrier on an identical side of the deep drawing foil, when the heating device and the model carrier are sequentially brought into positions relative to the deep drawing foil, which initially facilitates a controlled heating of the deep drawing foil and a subsequent form capture of the respective jaw model. Accordingly, the pressure forming device is configured so that the heating device and the model carrier are transferable in an alternating manner into an operating position along the operating axis using a movement device.

In particular, the heating device can be arranged relative to the deep drawing foil during the heating step, so that the heating device heats a portion of the deep drawing foil which is subsequently deep drawn over the jaw model. In order to perform this in the forming step, the jaw model is brought into position after performing the heating step, namely into the operating position that was previously occupied by the heating device, so that the jaw model is subsequently oriented for deep drawing the heated portion of the deep drawing foil over the jaw model. Advantageously, the deep drawing foil remains in position during the heating step and while preparing for the forming step and is not being moved.

This provides the option that the heating device is placed on one side of the deep drawing foil initially during the heating step of the deep drawing method, so that the deep drawing foil is heat-able by the heating device. Thus, the heating device is in an operating position where the heating device is arranged on or along the operating axis. When the heating device is arranged in its operating position, the heating device is arranged vertically below the deep drawing foil. After completing the heating step, the heating device can be moved from its operating position using the movement device, wherein the model carrier with a jaw model arranged thereon is moved into its operating position along or on the operating axis of the operating unit, when the model carrier is in a position relative to the heated deep drawing foil, wherein the model carrier can be deep drawn in the forming step over the jaw model that is supported on the model carrier. Thus, the movement device is configured and provided to move the heating device and the model carrier of the operating unit in an alternating manner into a position, namely, the respective operating position, relative to the deep drawing foil, so that the deep drawing process can be performed as intended.

In an advantageous embodiment, the heating device and the model carrier are arranged on a side of the deep drawing foil that is oriented away from the pressure device. Put differently, it is advantageous when the deep drawing foil is arranged between the pressure device on one side and the heating device or the model carrier on the other side. This facilitates, in particular, a cooperation of the deep drawing foil with different devices of the operating unit.

For example, and advantageously, the individual operating devices of the operating unit can be arranged in the following sequence, top down: pressure device-deep drawing foil-heating device/model carrier, depending on which of the two latter operating units is arranged along or on the operating axis in its operating position.

The pressure forming device according to the invention has many advantages, in particular, the pressure forming device facilitates heating the deep drawing foil from a side, wherein the jaw model is deep drawn over the side. Put differently, the heat radiation generated by the heating device directly impacts the surface of the deep drawing foil, where the deep drawing foil comes into direct contact with a corresponding surface of the respective jaw model when performing the forming step of the deep drawing process. It has become apparent that the temperature at locations of the deep drawing foil that are critical for high quality form capture can be adjusted particularly precisely. The prior art often heats a respective deep drawing foil using a heating device from a side oriented away from the jaw model or the model carrier. This renders a surface temperature of the deep drawing foil less controllable on a side oriented towards the model carrier. Thus, assuring a constant quality level of the form capture is less controllable in the prior art.

In an advantageous embodiment of the pressure forming device, the heating device and the model carrier are moveable by the movement device in an operating plane that is oriented perpendicular to the operating axis of the operating unit. Thus, the operating axis can be oriented vertically in particular so that the operating plane is oriented horizontally in that embodiment. The operating device can be formed, e.g., by a drawer in this embodiment, wherein the drawer is configured movable in a linear manner along the movement axis. Thus, the pressure forming device can include rails, for example, wherein the movement device configured as a drawer is moveable along the rails. Configuring the movement device in this manner has the advantage that the alternating transfer of the heating device and the model carrier into their operating positions can be performed in a particularly simple manner by hand or motor driven.

In a particularly advantageous configuration of the pressure forming device, the pressure forming device includes a plurality of operating units, respectively, including a heating device, a model carrier, and a pressure device. The operating axes of the operating devices are advantageously oriented vertically and parallel to one another. Additionally, it can be advantageous when arranging a plurality of operating devices to position the operating devices in series adjacent to one another so that the operating axes of the operating devices are arranged on a common operating plane. As described supra, the operating plane is advantageously oriented vertical. Arranging a plurality of operating units has the advantage that a plurality of form captures of different jaw models can be performed in a single deep drawing process. The pressure forming device can include a total of four operating units so that a total of four deep drawing foils or four portions of a single large deep drawing foil are heated in one heating step during a deep drawing process and subsequently deep drawn over an associated jaw model in a subsequent forming step. The pressure devices of the operating units can be supplied with pneumatic pressure by a single pressure generator in this embodiment. Thus, it is conceivable that the pressure forming device includes a compressor that is operatively connected by pressure conduits with the pressure devices of the operating units.

It is a particular advantage of using several operating units that each operating unit includes a model carrier of its own that is sized to receive a single jaw model. This way, an individual deep drawing foil or an individual associated section of a common deep drawing foil is used for receiving a plurality of jaw models for each jaw model. This has the advantage that the form captures of the jaw models do not influence each other negatively, e.g., due to a joint positioning on a single model carrier. The latter can have the effect that the jaw models are positioned too closely adjacent to one another, so that the interference described supra occurs which has a negative effect upon the quality of the form capture.

When the pressure forming device includes a plurality of operating units, it can be advantageous when the foil carrier is configured rectangular. Thus, the foil carrier extends along all operating units and includes a number of cutouts that correspond to the number of operating units. These cutouts are respectively associated with one of the operating units. The cutouts form deep drawing portions in this embodiment, wherein the deep drawing foil supported in the foil carrier is deep drawn over a respective jaw model in the deep drawing portions. The cutouts can respectively include, e.g. a form of a circular disc. The described embodiment has the advantage that not each of the operating units has to cooperate with a separate foil carrier in order to feed the respective operating unit with a deep drawing foil. Instead, a foil carrier is provided that is adjusted and sized according to the number of operating units, wherein the foil carrier is fed, in the simplest case, with an individual deep drawing foil. In order for the foil carrier to be able to cooperate with all operating units, the foil carrier extends along all operating units as described supra. In a case of producing a number of form captures below the number of operating units, it is possible in this embodiment to use a deep drawing foil whose dimensions are below dimensions of the foil carrier and thus do not use an entirety of the foil carrier. Thus, e.g. portions of the foil carrier that are associated with operating units that are not being used in the subsequent deep drawing process are not being fed. Thereafter, the deep drawing process is only performed in the operating units that are configured with the deep drawing foil and corresponding jaw models.

Thus, it is particularly advantageous when the pressure forming device is arranged and configured to activate the heating devices of the operating units for the heating step, depending on the foil carrier being configured with the deep drawing foil for the respective operating unit. Thus, it is conceivable, for example, that the pressure forming device includes a plurality of sensors that monitor the foil carrier with respect to which areas of the foil carrier or which cutouts are configured with the deep drawing foil. The sensors can be operatively connected with a control device of the pressure forming device so that the control device can process the information captured by the sensor and so that the control device controls the heating devices of the operating units accordingly. This configuration facilitates operating the pressure forming device in a particularly efficient manner, wherein energy for heating the deep drawing foil is only used in areas in which the deep drawing foil actually has to be heated.

In an advantageous embodiment, the foil carrier is configured as a drawer that is moveable in a linear manner between a feeding position and a heating position. In the feeding position, the foil carrier is manually feedable with at least one deep drawing foil. When the foil carrier is arranged in its feeding position, the foil carrier is advantageously arranged partially outside of the housing, so that manual access to the foil carrier is possible in a particularly simple manner. In the heating position, the foil carrier is arranged relative to the heating device arranged in the operating position so that a deep drawing foil arranged on the foil carrier is heatable by the heating device. When the foil carrier is arranged in the heating position, the foil carrier is advantageously arranged within the housing. Configuring the foil carrier as a drawer has the advantage that the foil carrier can be fed with one or plural deep drawing foils in a particularly simple manner and can be positioned thereafter relative to the heating device. In the simplest case, the foil carrier is moveably supported for this purpose along a linear movement axis, wherein this movement axis is advantageously oriented perpendicular to the operating axis of the operating unit. When the operating axis of the operating unit is advantageously oriented vertically, the movement axis of the foil carrier is advantageously oriented horizontally.

Advantageously, the pressure forming device additionally includes a switch that is arranged so that it is activated when the foil carrier is moved into its heating position. The switch is operatively connected with a control device of the pressure forming device, which is configured to activate the heating device due to the actuation of the switch. This configuration has the particular advantage that the start of the heating step of the deep drawing process does not have to be initiated by an additional manipulation but is initiated by the switch automatically when the foil carrier is moved into its heating position. The latter can be performed in a particularly simple manner by hand or in an automated manner.

In another advantageous embodiment of the pressure forming device, the pressure device of the at least one operating unit is transferrable between an idle position and a pressure position. In order to transfer the pressure device between these two conditions, the pressure cylinder of the pressure device is moveable along the operating axis of the operating unit in a direction towards the model carrier. The pressure condition of the pressure device is reached when the pressure device is operatively connected with the model carrier. This operating connection can be provided indirectly or directly and is characterized in that the pressure cylinder of the pressure device seals tight with a surface of the deep drawing foil or seals tight with a surface of the model carrier, and the deep drawing foil contacts the model carrier. This condition provides the option to deep draw the heated deep drawing foil over the jaw model by the pneumatic pressure provided by the pressure device, wherein the deep drawing foil is soft and deformable due to the heating.

Advantageously, the tight sealing of the pressure cylinder is caused by the tight sealing contact at the deep drawing foil. Thus, the deep drawing foil defines a pressure cavity together with the pressure cylinder wherein the pressure cavity is arranged in the pressure cylinder and the pneumatic pressure is generatable therein. The pressure impacts the surface of the deep drawing foil and is therefore configured to press the deep drawing foil over the jaw model. Advantageously, the pneumatic pressure is a positive pressure, so that the deep drawing foil is pressed over the jaw model. This is advantageous in particular when the model carrier and the pressure device are arranged on opposite sides of the deep drawing foil. Alternatively, a negative pressure can also be applied in order to suction or pull the deep drawing foil over the jaw model.

According to an advantageous embodiment of the pressure forming device, the pressure cylinder of the pressure forming device is connected with a pressure generator through a pressure conduit. The latter is arranged and configured to generate a pneumatic pressure. The pressure generator can be formed by a compressor. Since the pressure generator is connected with the pressure cylinder through the pressure conduit, a positive pressure or negative pressure can be generated in the pressure cylinder by the pressure generator in order to perform the forming step of the deep drawing process and the positive pressure or the negative pressure can be applied upon the deep drawing foil through the pressure cylinder as described supra. This way, the deep drawing process can be performed in a particularly simple manner. The pressure generator can also be formed by a vacuum pump in case the deep drawing process shall be performed by applying a vacuum.

According to an advantageous embodiment, the pressure device includes an actuation cylinder, wherein the pressure cylinder is supported in the actuation cylinder as a piston. This embodiment facilitates a particularly simple movement mechanism for the pressure cylinder, wherein the pressure device is transferrable between the idle position described supra and the pressure condition. This provides an opportunity to move the pressure cylinder along the operating axis of the operating unit. In this embodiment, the actuation cylinder defines a pressure cavity together with the pressure cylinder, wherein the pressure cavity is connected with the pressure generator through a pressure conduit. This can be the same pressure generator that supplies the pressure cylinder with the pneumatic pressure. It is also conceivable that this is an additional or different pressure generator. Applying a pneumatic pressure in the pressure cavity of the actuation cylinder moves the pressure cylinder that functions as a piston of the actuation cylinder along a center axis of the actuation cylinder. Accordingly, the actuation cylinder is arranged so that its center axis coincides with the operating axis of the operating unit.

It can be furthermore advantageous in the described embodiment when the pressure forming device includes at least one reset device which is configured, e.g. in a form of a gas spring. The reset device is configured and arranged to retract the pressure cylinder back into the actuation cylinder after being deployed from the actuation cylinder and after completing the forming step. Put differently, the reset device is used to move the pressure device from its pressure condition back into its idle position as soon as the pneumatic pressure is released in the pressure cavity of the actuation cylinder, so that the reset device is kept in the idle condition thereafter. Accordingly, it is required in this embodiment for extending the pressure cylinder along the operating axis of the operating unit that a preset preload force of the reset device is overcome. An amount of the pressure in the pressure cavity of the actuation cylinder has to be adjusted accordingly.

According to an advantageous embodiment, the foil carrier is moveable together with the pressure cylinder. This is advantageous in particular for a configuration of the pressure forming device where the foil carrier is moveable between a feeding position and a heating position as described supra. In order to transfer the pressure device into its pressure condition, the pressure cylinder is advantageously moved along the operating axis of the operating unit in a direction towards the model carrier as described supra. The movability of the foil carrier together with the pressure cylinder helps to bring the model carrier, the deep drawing foil, and the pressure cylinder into operating connection. Thus, the pressure cylinder can move the previously heated deep drawing foil along until a surface of the deep drawing foil oriented towards the heating device or the model carrier comes in contact with a surface of the model carrier. An additional press contact of the pressure cylinder then achieves a tightly sealed connection between the pressure cylinder and a surface of the deep drawing foil that is oriented towards the pressure cylinder and between the model carrier and the surface of the deep drawing foil oriented towards the model carrier. After this has been done, the forming step of the deep drawing process can be performed in a particularly simple manner, namely, in that a pneumatic pressure, advantageously a positive pressure, is built up in the pressure cylinder. Thus, the deep drawing foil is pressed onto the jaw model and the shape of the jaw model is captured by the deep drawing foil in the form of a negative. This condition is then maintained for a certain time period, “cooling time”, to cool the deep drawing foil and render it rigid and shape-stable before the pressure is released. This completes the forming step.

In order for the foil carrier to be moveable together with the pressure cylinder, the foil carrier can be supportable at the pressure cylinder, e.g. by at least one magnet. Since the foil carrier remains at the model carrier or at a jaw model supported on the model carrier after completing the forming step and the pressure cylinder has to be moved away from the model carrier along the operating axis, so that the pressure device is transferred back into the idle condition, it can be provided that the foil carrier is decoupled from the pressure cylinder before transferring the pressure device back into the idle condition, so that the foil carrier remains in an area of the model carrier. This can be performed, e.g. by an interlocking mechanism, which overcomes the attachment of the foil carrier at the pressure cylinder so that the foil carrier and the pressure cylinder are separated from each other.

This configuration, where the foil carrier is moveable along the operating axis of the operating unit, facilitates direct contact of a heated deep drawing foil with the model carrier without interfering with the movement device which is configured to transfer the heating device and the model carrier between its respective operating position.

Independently from the advantageous embodiment described supra, it can be particularly advantageous when the pressure forming device includes a control device which is configured and provided to control the heating device and/or the pressure device of the at least one operating unit in order to perform a deep drawing process. This control device facilitates automating a deep drawing process at least partially, advantageously completely. Advantageously, the control device is configured to automatically adjust a heating time, during which the respective deep drawing foil is heated by the heating device during the heating step as a function of a type of deep drawing foil that is being used. A manual input of a user of the pressure forming device can be used to identify the deep drawing foil. In an advantageous embodiment, the pressure forming device is configured with a scanner that is able to detect a coding, e.g. a barcode or a QR code of a deep drawing foil. The scanner is operatively connected with the control device, so that the control device is able to process the information captured by the scanner and to control the heating device as a function thereof.

This type of control device is particularly advantageous for a pressure forming device that includes a plurality of operating units as described supra. Thus, the control device is configured and arranged to automatically activate the heating devices of the operating units automatically to perform the heating step of the deep drawing process only when the foil carrier for the respective operating unit is configured with a deep drawing foil. The advantages thus created are already described supra. In particular, the pressure forming device can be operated as required so that only those heating devices consume electricity that are required to heat the deep drawing foil.

The object is also achieved by a method for performing a deep drawing process for deep drawing a deep drawing foil over at least one jaw model using a pressure forming device, the method including loading a foil carrier with the deep drawing foil; heating the deep drawing foil in a heating step of the deep drawing process using a heating device, so that the deep drawing foil is configured to be deep drawn over a jaw model; after completing the heating step, moving a pressure cylinder of a pressure device and a model carrier supporting the jaw model along an operating axis towards each other, so that the pressure device and the model carrier come into indirect or direct operating engagement; deep drawing the deep drawing foil in a forming step of the deep drawing process over the jaw model by a pneumatic pressure generated in the pressure cylinder of the pressure device; and after completing the heating step and before performing the forming step, moving the heating device from an operating position of the heating device, where the heating device is arranged along the operating axis on one side of the deep drawing foil using a movement device and moving the model carrier into an operating position of the model carrier using the movement device, wherein the model carrier is arranged along the operating axis on the one side of the deep drawing foil in the operating position of the model carrier.

Advantageous embodiments can be derived from the dependent claims.

The method according to the invention is characterized in that the heating device is moved by a movement device from its operating position and the model carrier is moved into its operating position by the movement device after completing the heating step and before performing the forming step. According to the preceding description, the heating device as well as the model carrier are arranged along or on the operating axis of the at least one operating unit when provided in their respective operating positions. Put differently, the heating device and the model carrier of the operating unit switch positions after completing the heating step so that the model carrier including the jaw model supported thereon are positioned to perform the forming step of the deep drawing process. Thus, the heating device and the model carrier are arranged on the same side of the deep drawing foil. Advantageously, this side is the side of the deep drawing foil that is oriented away from the pressure device.

The method according to the invention is performable in a particularly simple manner using the pressure forming device according to the invention. The associated advantages are already described supra.

In a particularly advantageous embodiment of the method, the movement device performs the movement of the heating device from its operating position and the moment of the model carrier into its operating position as a joint movement. Put differently, the heating device and the model carrier are not respectively moved individually but jointly. This joint movement can be performed in a particularly simple manner when the movement device is formed by a drawer as described supra, wherein the heating device as well as the model carrier are arranged on the drawer. In this embodiment, only the drawer has to be moved, e.g. manually in order to move the heating device as well as the model carrier in a joint movement.

Additional time savings can be achieved by advantageously heating the deep drawing foil concurrently with feeding the model carrier.

According to an advantageous embodiment of the method, the heating device of the operating unit is activated automatically as soon as the foil carrier, including the deep drawing foil arranged thereon, is moved into a heating position. The heating position is characterized in that the deep drawing foil is heated by the heating device in order to perform the forming step of the deep drawing method after the heating. The automatic actuation of the heating device when transferring the foil carrier into the heating device has the advantage that manual operation, which has the same effect, can be omitted. Thus, the method can be performed in a particularly time-saving and simple manner. The automatic actuation of the heating device can be performed in particular by the switch described supra which triggers due to the transfer of the foil carrier into its heating position.

Additionally, the method can be particularly advantageous when the pressure forming device includes a plurality of operating units which respectively include a pressure device, a heating device, and a model carrier, wherein only heating devices are activated for performing the heating step, where the associated foil carrier is configured with a deep drawing foil. The advantages thus obtained are described supra. In particular, energy for heating the deep drawing foil only has to be used in heating devices that are actually provided in the respective heating step for heating a deep drawing foil.

According to an advantageous embodiment, the pressure device is automatically transferred from its idle position into its pressure condition in order to perform the forming step due to the control by the control device. Thus, a pressure cylinder of the pressure device is moved towards the model carrier and a pneumatic pressure in a pressure cavity of the pressure cylinder is automatically generated after indirect or direct engagement with the model carrier. This pressure is imparted upon the deep drawing foil accordingly so that the deep drawing foil is deep drawn over the respective jaw model that is supported on the model carrier. The pressure that is built up in the pressure cylinder can be formed in particular by a positive pressure. As a matter of principle, it is also conceivable that a negative pressure is generated in the pressure cylinder or in its pressure cavity, wherein the forming step is performed by the negative pressure. Advantageously, the pressure cylinder can be pneumatically driven in order to move from its idle position into its pressure condition. This has already been described supra for the pressure forming device.

The method described supra has the particular advantage that a respective deep drawing method can be substantially performed without manual interaction by the user of the pressure forming device. Thus, performing the method is particularly simple. Additionally, errors that result from manual operation are precluded when performing the automated method described supra. A typical error is waiting too long after completing the heating step before starting the forming step, so that the temperature of the deep drawing foil is reduced and its suitability for the forming step decreases. The automation starts the forming step in a timed manner after the heating step so that the respective deep drawing foil is in an ideal condition for deep drawing over the respective jaw model. Automatically performing the forming step is implementable in a particularly simple manner when the pressure device includes an actuation cylinder in addition to the pressure cylinder as described supra. In this embodiment, the movement of the pressure cylinder can be automatically triggered by a control device in a particularly simple manner by controlling valves so that a pressure is established in the pressure cavity of the actuation cylinder, so that the pressure cylinder is moved along the operating axis towards the model carrier until the pressure cylinder is in its pressure condition and the forming step can commence.

Last, not least, an embodiment of the method is particularly advantageous where the pneumatic pressure of the pressure device is automatically released by a control device after a cooling time and the pressure device is automatically transferred back into its idle position. This terminates the forming step of the deep drawing method. Automatically releasing the pressure can be performed by controlling valves. A subsequent transfer of the pressure device back into its idle position can be performed in a particularly simple manner by at least one reset device as described supra. The automatic completion of the forming step in the manner described supra also has the advantage of preventing errors in operating the pressure forming device. In particular, it is being excluded that pressure from the pressure device is released prematurely while the temperature of the deep drawing foil has not dropped sufficiently yet. This could cause an unintentional subsequent deformation of the deep drawing foil so that the form capture of the respective jaw model is not performed with the desired quality. Monitoring an appropriate cooling time using a control device and an automated release of the pressure device is preferred.

### BRIEF DESCRIPTION OF THE DRAWINGS

The invention is subsequently described based on an advantageous embodiment with reference to drawing figures, wherein:

FIG. 1 illustrates a perspective view of a pressure forming device according to the invention

FIG. 2 illustrates a vertical cross-sectional view of the pressure forming device according to FIG. 1;

FIG. 3 illustrates a cross-sectional view according to FIG. 2 during a heating step of a deep drawing method performed by the pressure forming device;

FIG. 4 illustrates the cross-sectional view according to FIG. 2 during an intermediary step between the heating step according to FIG. 3 and a subsequent forming step of the deep drawing method.

FIG. 5 illustrates the cross-sectional view according to FIG. 2 during the forming step of the deep drawing method; and

FIG. 6 illustrates a horizontal cross-sectional view of the pressure forming device according to FIG. 1.

### DETAILED DESCRIPTION OF THE INVENTION

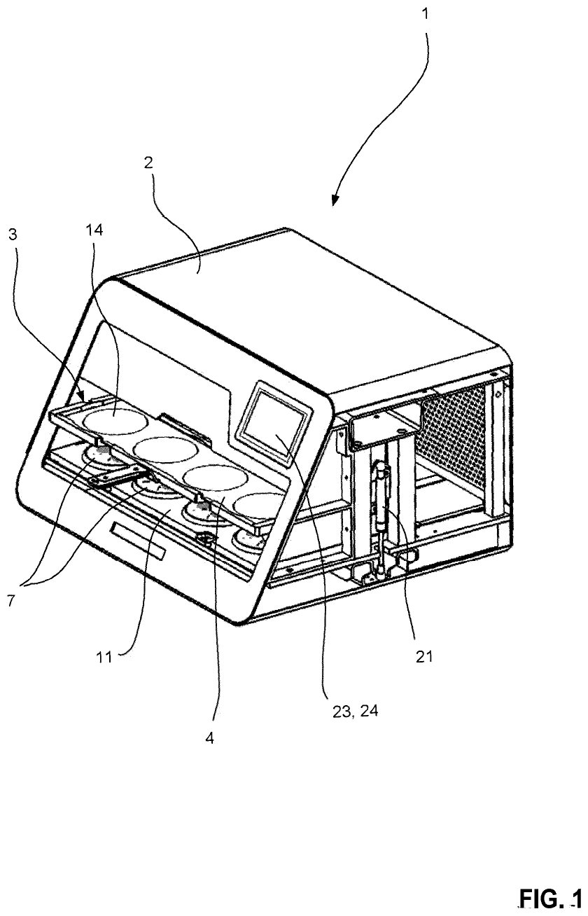

An embodiment illustrated in FIGS. 1-6 includes a pressure forming device 1 according to the invention configured for dental deep drawing. Thus, the pressure forming device 1 is configured to produce active orthodontic treatment elements. The elements are produced by deep drawing a deep drawing foil over a previously produced jaw model which is a positive of teeth of a patient. The deep drawing foil is processed after deep drawing so that an aligner is produced.

The pressure forming device 1 includes a housing 2 that includes a total of four operating units 5. The operating units 5 are arranged in series adjacent to one another along a transversal axis 26 of the pressure forming device 1. Each of the operating units 5 includes a heating device 6, a model carrier 7, and a pressure device 9. The heating devices 6 are configured to heat a deep drawing foil 4 so that the deep drawing foil 4 is configured to be deep drawn over a respective jaw model 8. The heating devices 6 are formed by a known heat radiator in the illustrated embodiment.

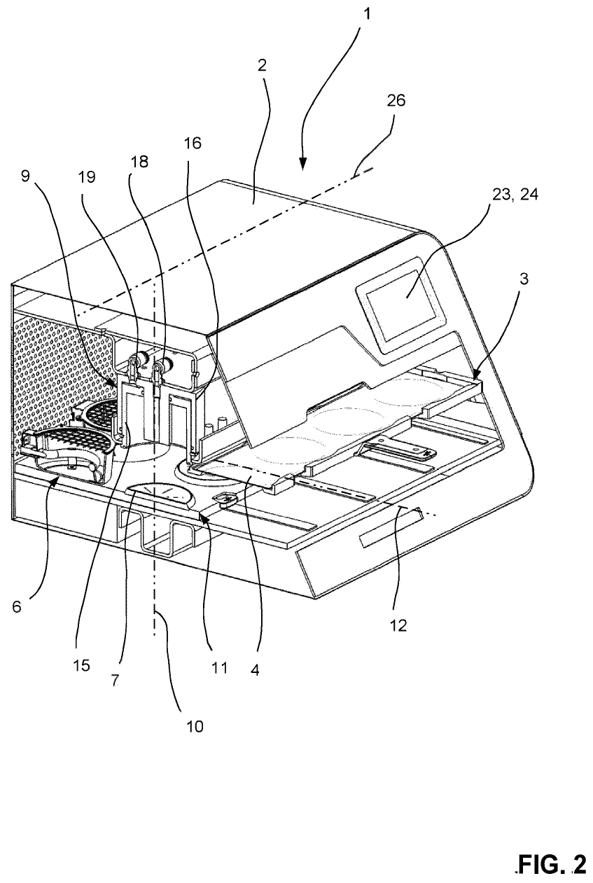

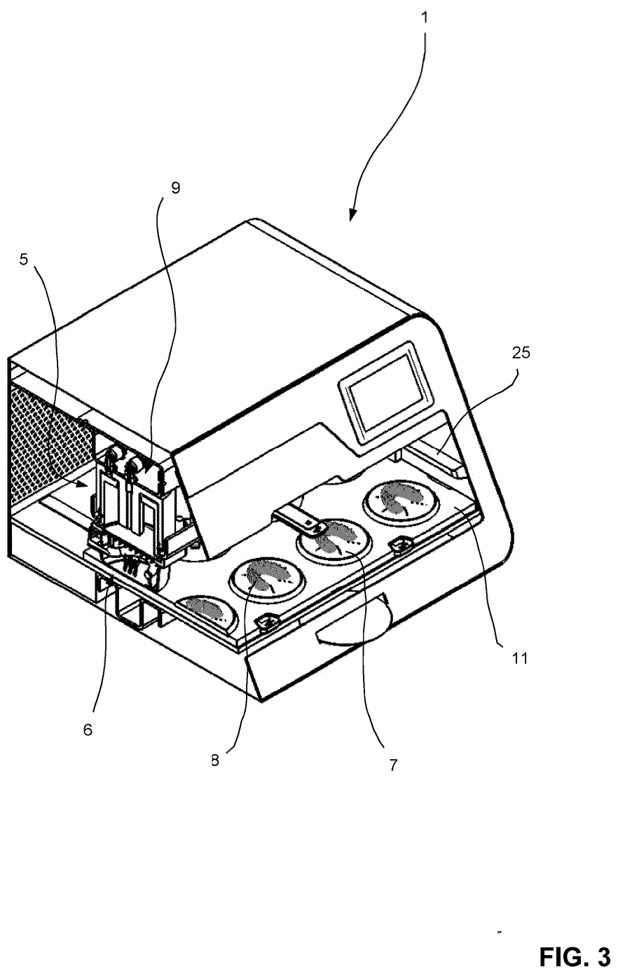

The deep drawing foil 4 that is processed in a respective deep drawing process is supported by a foil carrier 3 of the pressure forming device 1. The foil carrier 3 is evident from FIGS. 1 and 2. In the illustrated embodiment, the foil carrier is configured as a drawer that is moveable along a movement axis between a feed position shown in FIG. 2 and a heating position shown in FIG. 3. The foil carrier 3 is loadable with a deep drawing foil 4 in a particularly simple manner in the loading position where the foil carrier 3 is partially outside of the housing 2. This can be performed in a particularly simple manner by manually inserting a respective deep drawing foil 4 into the foil carrier 3. The foil carrier 3 is supported by lateral carrier supports 25 that are arranged at the housing 2 when the foil carrier 3 is in the loading position. In order to move the foil carrier 3 from the loading position into the heating position, the foil carrier 3 can be inserted into the housing 2 on the carrier supports 25 along the movement axis. Thus, the movement axis is oriented horizontally, this means the foil carrier 3 is inserted into the housing 2 in a horizontal direction when transferred into its heating position.

The foil carrier 3 is configured elongated in a lateral direction of the pressure forming device 1 in the illustrated embodiment, wherein the foil carrier 3 extends along all operating units 5. This way, the foil carrier 3 is configured to receive a rectangular deep drawing foil 4 that also extends along all operating units 5. As evident from FIG. 1, the foil carrier 3 includes a plurality of cutouts 14 that corresponds to a number of the operating units 5, wherein each of the cutouts 14 is associated with one of the operating units 5. Accordingly, the heating units 6 are configured to heat the deep drawing foil 4 in areas of the cutouts 14, wherein each heating device 6 is associated with another cutout 14. The cutouts 14 which are advantageously configured circular, facilitate deep drawing foil 4 over a respective jaw model 8. Thus, a respective jaw model 8 penetrates through an associated cutout 14 of the foil carrier 3 into the deep drawing foil 4 so that the deep drawing foil 4 is placed over the jaw model 8 and can thus cause the form capture of the jaw model 8. The elongated configuration of the foil carrier 3 has the advantage that all operating units 5 can be loaded with a single deep drawing foil 4 so that the complexity of applying a separate deep drawing foil 4 for each operating unit 5 can be omitted. In case only a portion of the operating units 5 shall be used for an intended deep drawing process, it is feasible to place a deep drawing foil 4 onto the foil carrier 3, wherein the deep drawing foil 4 is smaller than the foil carrier 3. Thus, it can be advantageous or required depending on the configuration of the pressure forming device 1 to load cutouts 14 of the foil carrier 3 that are not covered by the deep drawing foil 4 with a placeholder in order to facilitate operations of the pressure device 9 of the operating units 5.

The pressure devices 9 are configured in two pieces in the illustrated embodiment and accordingly respectively include an actuation cylinder 16 and a pressure cylinder 15. The pressure cylinder 15 of a respective pressure device 9 is supported as a piston in the respective actuation cylinder 16. Thus, the pressure cylinder 15 and the actuation cylinder 16 jointly define a pressure cavity 17 that facilitates to move the pressure cylinder 15 relative to the actuation cylinder 16 by applying a pneumatic pressure in the pressure cavity 17. This movement is performed along an operating axis 10 of the respective operating unit 5. The operating axes 10 of the operating unit 5 are respectively oriented vertically in the illustrated embodiment and are jointly arranged in an operating plane. This configuration of the pressure device 9 facilitates moving the deep drawing foil 4 towards the model carrier 7 after performing the heating step of the respective deep drawing method and to cause a contact between the deep drawing foil 4 and the jaw models 8 supported on the model carriers 7.

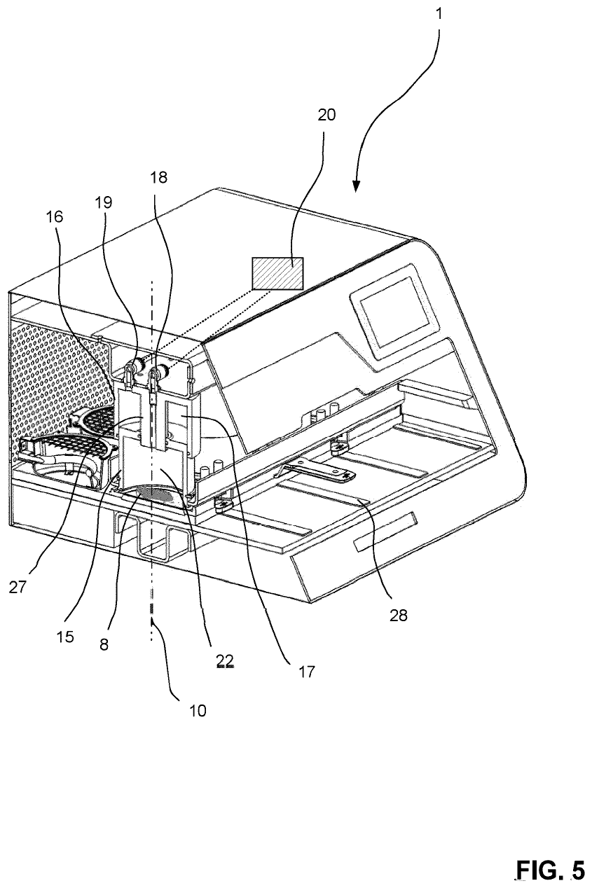

The operating cavity 17 is connected by a pressure conduit 19 with a pressure generator 20, in order to generate pneumatic pressure in the operating cavity 17 of the actuation cylinder 16. The pressure generator 20 is schematically illustrated in FIG. 5. The pressure generator 20 can be configured e.g. as a compressor that provides compressed air. The pressure device 9 includes a valve in order to drain a pressure built up in the pressure cavity 17 and in order to be able to retract the pressure cylinder 15 again after being deployed from the actuation cylinder 16. A pneumatic positive pressure is generated in a pressure cavity 22 of the pressure cylinder 15 in order to perform a forming step. This has the effect that the previously heated deep drawing foil 4 is pressed over a respective jaw model 8 and applied to the jaw model 8 precisely fitted in order to capture the shape of the jaw model 8. Thus, the pressure cavity 22 is operatively connected with the pressure generator 20 through a pressure conduit 18. Air compressed by the pressure generator 20 is conducted into the pressure cavity 22 of the pressure cylinder 15 along a portion of a shaft 27 of the actuation cylinder 16 that extends along the operating axis 10 and that is provided with an axial borehole. The axial borehole leads into the pressure cavity 22 as evident form FIG. 5.

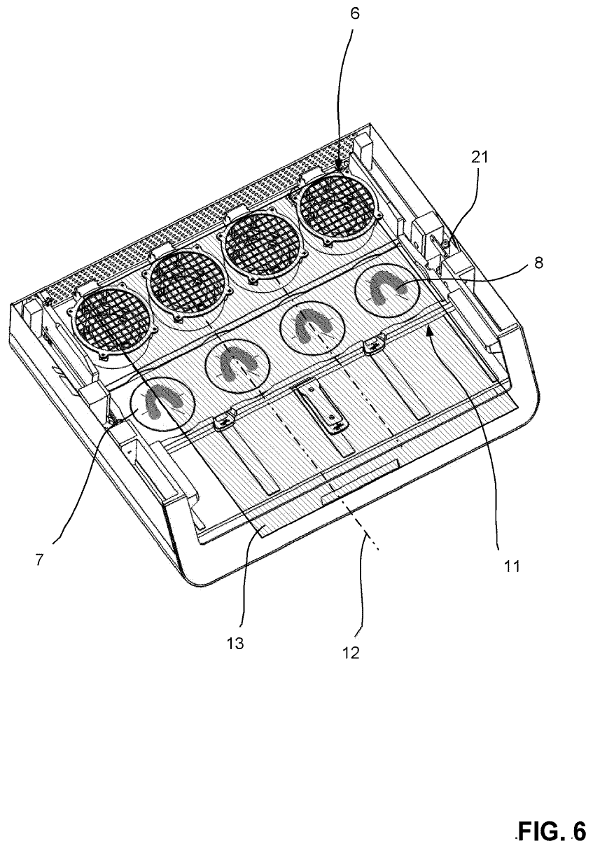

The heating device 6 and the model carrier 7 of a respective operating unit 5 are respectively jointly supported in the housing 2 by a movement device 11. The movement device 11 is formed by a drawer in the illustrated embodiment, wherein the drawer is moveable on a linear path, guided by rails 28 along movement axes 12. The movement of the movement device 11 is thus performed within or parallel to an operating plane 13 that is illustrated in FIG. 6. The operating plane 13 is oriented perpendicular to each of the operating axes 10 of the operating units 5 and thus oriented horizontally. Thus, the movement device 11 is configured to move the heating devices 6 and the model carrier 7 in a direction perpendicular to the operating axes 10. This way, the heating devices 6 and the model carrier 7 can assume their respective operating positions in an alternating manner, wherein the heating device 6 and the model carrier 7 are respectively arranged along the respective operating axis 10 of the associated operating unit 5. The condition illustrated in FIG. 2 shows the model carriers 7 respectively arranged in their operating positions since the model carriers 7 are arranged along or on the operating axes 10. Vice versa, it is shown in FIG. 3 that the heating devices 6 are arranged in their respective operating position. Since the heating devices 6 and the model carrier 7 are jointly arranged on the movement device 11 the respective transfer in the respective operating position is performed as a joint movement.

The individual components of the pressure forming device 1 are arranged in the illustrated embodiment so that the pressure devices 9 are supported above the foil carrier 3 or a deep drawing foil 4 supported therein and so that the deep drawing foil 4 is arranged above the movement device 11 with the heating devices 6 and the model carriers 7. Accordingly, the heating devices 6 and the model carriers 7 are arranged on a common side of the deep drawing foil 4, which is a bottom side of the deep drawing foil 4 in the illustrated embodiment. The pressure devices 9 are associated with a top side of the deep drawing foil 4, so that the pressure devices 9 and the heating devices 6 and the model carrier 7 are associated with opposite sides of the deep drawing foil 4.

The pressure forming device 1 additionally includes a control device 23 that cooperates with an operating panel 24. The operating panel 24 is formed in the illustrated embodiment by a combined input-/display device, configured as a touch display, which displays information to a user of the pressure forming device 1 and enables the user to enter information. The control device 23 is configured to control at least the pressure devices 9 and the heating devices 6. Thus, a deep drawing method can be performed as follows:

Before performing a deep drawing method, the foil carrier 3 is in a loading position. The movement device 11 is positioned so that the heating devices 6 are respectively arranged in their operating position along or on the operating axes 10 of the operating units 5. Accordingly, the model carriers 7 protrude from a front end of the housing 2 so that they can be respectively manually loaded with a jaw model. Thus, a jaw model 8 is placed onto each of the model carriers 7. The model carriers 7 are respectively provided to receive a single jaw model 8 and are configured circular, wherein the respective jaw models 8 are centrally placed onto an associated model carrier 7. This condition of the pressure forming device 1 is illustrated in FIG. 1.

The foil carrier 3 is loaded with a deep drawing foil 4. All operating units 5 are respectively used for performing a deep drawing process in this embodiment. Accordingly, the deep drawing foil 4 is sized so that it covers an entirety of the foil carrier 3. Consequently, deep drawing foil 4 is associated with all four cutouts 14 of the foil carrier 3.

The foil carrier 3 is manually transferred into its heating position after insertion of the deep drawing foil 4 by manually sliding the foil carrier 3 into the housing 2 in a horizontal direction. When the foil carrier is arranged in the heating position, it is arranged below the pressure devices 9 and above the heating devices 6 that are arranged in their operating positions. With reference to one of the operating devices 5, the pressure device 9, the deep drawing foil 4, and the heating device 6 are jointly arranged along or on the operating axis 10 of the respective operating unit 5 and thus in series. This is shown in FIG. 3. In the illustrated embodiment, the pressure forming device 1 includes a switch, which is activated by transferring the foil carrier 3 into the heating position. The switch is operatively connected with the control device 23, so that the control device 23 automatically activates the heating devices 6 when the switch is activated. The actuation of the heating devices 6 is also based on additional sensors that monitor the loading of the foil carrier 3 for a respective operating unit 5 with deep drawing foil 4. When no deep drawing foil 4 is provided at a cutout 14 of the foil carrier 3, the heating devices 6 are controlled so that a heating device 6 associated with the respective operating unit 5 is not activated. Since all operating units 5 are loaded with the deep drawing foil 4 in the illustrated embodiment, all heating devices 6 are activated to perform the deep drawing process. This marks the beginning of the heating step of the deep drawing process.

The duration of the heating step or heating time is a function of the deep drawing foil 4 being used, in particular, what thickness the respective deep drawing foil 4 has and/or from which material the deep drawing foil 4 is formed. The pressure forming device 1 can be configured, e.g. with a scanner that is able to identify the deep drawing foil 4 of the respective subsequent deep drawing process. The identification can be provided by a code on the deep drawing foil 4, wherein the code is optically detectable by the scanner. The control device 23 is configured to control the heating devices 6 or adjust the heating time as a function of the respective deep drawing foil 4 that is being used. It is also conceivable that manual entries are made through the operating panel 24 with respect to operations of the heating devices 6. This can relate to a temperature of the heating devices 6 as well as to the heating time. The deep drawing foil 4 is heated by the heating devices 6 at a side oriented away from the pressure devices 9 during the heating step. The pressure forming device 1 can also include one or plural temperature sensors that are able to detect a temperature of the deep drawing foil 4 at a bottom side in an area of the cutouts 14 of the foil carrier 3. This enables a check on whether the deep drawing foil 4 has been heated sufficiently and whether the heating step can be terminated.

The model carrier 7 can be loaded with jaw models 8 during the heating step, in particular, manually loaded by a user of the pressure forming device 1.

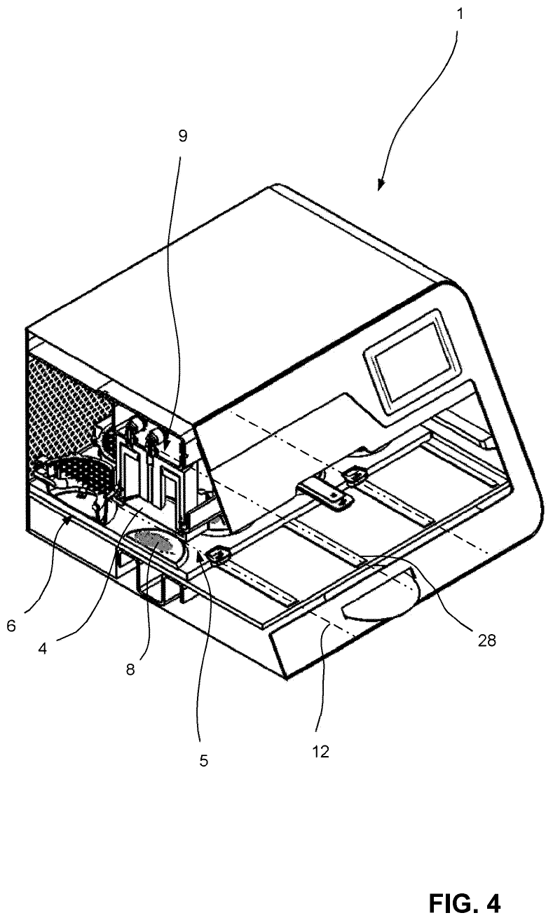

The heating devices 6 are moved from their respective operating positions along or away from the operating axes 10 of the operating units 5 after completing the heating step and the model carriers 7 are moved into their respective operating positions instead. The model carriers 7 consequently are in a location that was occupied by the heating devices 6 before. This is done by the movement device 11 as described supra, wherein the movement device 11 is manually moved in a direction of the movement axis 12. The movement of the movement device 11 marks an intermediary step that is performed subsequent to the heating step and that is performed before the forming step. The pressure forming device 1 is in the condition illustrated in FIG. 4 after performing the intermediary step. In this condition, the pressure device 9, the deep drawing foil 4, and the model carrier 7 are jointly arranged along or on the operating axis 10 of the respective operating unit 5 in series.

As soon as the model carriers 7 are in their operating positions, the forming step is carried out in another intermediary step. Thus, the pressure cylinders 15 of the pressure devices 9 are deployed along the operating axes 10, starting from an idle position of the pressure devices 9 until the pressure cylinders 15 come into indirect or direct operating connection with the respective model carrier 7. The pressure cylinders 15 are moved vertically downward along the operating axes 10, using the actuation cylinders 16 in the illustrated embodiment. This movement is performed together with the foil carrier 3 and the heated deep drawing foil 4 supported therein. For this purpose, the foil carrier 3 is supported at least at a portion of the pressure cylinders 15 of the pressure device 9 when the foil carrier 3 is in its heating position in the illustrated embodiment. This is performed in the illustrated embodiment by magnets. The magnets have received the foil carrier 3 from the carrier supports 25 when the foil carrier 3 was moved from its loading position into its heating position. The magnets are used to fix the foil carrier in the heating position at the pressure cylinders 15. Supporting the foil carrier 3 at the pressure cylinders 15 has the advantage that the foil carrier 3 follows the movements of the pressure cylinders 15 along the operating axes 10. Put differently, the pressure cylinders 15 and the foil carrier 3 are jointly transferred from their respective idle positions into their respective pressure conditions during the transition of the pressure device 9.

Thereafter, the pressure cavity 17 of the actuation cylinders 16 of the pressure devices 9 are loaded with pneumatic pressure by the pressure generator 20 before performing the forming step so that the pressure cylinders 15 are extended. Thus, the pressure cylinders move along the respective operating axis 10 in a vertical direction towards the respectively associated model carrier 7. This movement is performed until the deep drawing foil 4 contacts a surface of the model carrier 7 that is oriented towards the deep drawing foil 4. Another extension of the pressure cylinder 15 thus causes a pressing of the deep drawing foil 4 against the model carrier 7 and a pressing of a circumferential axial seal of the respective pressure cylinder 15 against the deep drawing foil 4. The pressure cylinder 15 or the pressure device 9 are in indirect engagement with the model carrier 7 in the illustrated embodiment, wherein the indirectness is caused by the deep drawing foil 4 arranged between the model carrier 7 and the pressure cylinder 15. This way, the pressure cavity 22 of the respective pressure cylinder 15 is sealed tightly, defined by the walls of the pressure cylinder 15 itself and by the deep drawing foil 4. Thus, the pressure devices 9 are provided in their pressure condition. Thereafter, the form capture of the jaw models 8 that are supported on the model carrier 7 has to be performed.

Then, the forming step starts. Thus, the pressure cavities 22 of the pressure cylinders 15 are respectively loaded with a pneumatic pressure that is provided by the pressure generator 20. This causes the heated and thus deformable deep drawing foil 4 to be pressed over the respective jaw model 8 so that the deep drawing foil 4 is applied to the jaw model 8 precisely fitting. Since the bottom side of the deep drawing foil 4 is pressed tightly against the respective model carrier 7, the model carriers 7 respectively include a plurality of vent openings for venting an air volume captured between the deep drawing foil 4 and the respective model carrier 7, wherein excess air can escape through the vent openings in the illustrated embodiment. This way, the deep drawing foil 4 can apply precisely fitting to the jaw models 8 without interfering air enclosures.

In this condition, where the pressure cavities 22 of the pressure cylinders 15 are loaded with pressure, the pressure forming device 1 subsequently remains for a cooling time in which the temperature of the deep drawing foil 4 decreases and the deep drawing foil 4 therefore hardens again. The duration of the cooling time can be predetermined in particular by the control device 23. The positive pressure is released from the pressure cavities after completion of the cooling time and thereafter the pressure cylinders 15 can retract again along the operating axes 10 into their associated actuation cylinders 16. The forming step is thus completed. The bleeding of the positive pressure is also triggered due to the control by the control device 23. The illustrated pressure forming device 1 includes two reset devices 21, arranged laterally opposite from each other at the housing 2 for retracting the pressure cylinders 15, wherein the reset devices are respectively formed by a gas spring. The reset devices 21 are preloaded so that they retract the pressure cylinders 15 into the associated actuation cylinder 16 when a positive pressure is not present in the respective pressure cavity 17. Thus, the pressure devices 9 are transferred back into their idle position and retained in the idle position.

Last, not least, the movement device 11 is moved back so that the heating devices 6 are respectively provided in their operating positions and the model carrier 7, including the jaw models 8 arranged thereon and the deep drawing foil 4 drawn over the jaw models 8 protrude from a front end of the housing 2. The foil carriers 3 are in a position that is lower than the loading position when the forming step of the deep drawing process is completed, wherein the lower position has been assumed for performing the forming step. In order to retain the foil carrier 3 in this position when the pressure cylinders 15 pull back into the actuation cylinders 16, the foil carrier is retained by mechanical retaining devices that engage the foil carrier 3 by positive form locking as soon as the foil carrier 3 has been lowered down to the movement device 11 or the model carriers 7. When moving the pressure cylinders 15 up after completion of the forming step, the magnetic retaining force is overcome that exists between the magnets arranged at the pressure cylinders 15 and the foil carrier 3, so that the foil carrier 3 disengages from the pressure cylinders 15 and remains in the lowered position.

The foil carrier 3 is subsequently moved by the movement device 11 in a horizontal direction or perpendicular to the operating axes 10 out of the housing 2 and can eventually be extracted by hand, wherein the deep drawing foil 4 that is deep drawn over the jaw models 8 is retrieved. Since the jaw models 8 are enveloped by the deep drawing foil 4 as a matter of principle, the jaw models 8 are also retrieved, which are captured and encased by the deep drawing foil 4. In order to eventually fabricate the finished retainers for respective orthodontic treatments, it is only required to cut the individual foil sections that represent negatives of the jaw models whose shape has been captured, wherein the retainers are cut from the deep drawing foil 4 in a known manner.

### REFERENCE NUMERALS AND DESIGNATIONS

1 pressure forming device
2 housing
3 foil carrier
4 deep drawing foil
5 operating unit
6 heating device
7 model carrier
8 jaw model
9 pressure device
10 operating axis
11 movement device
12 movement axis
13 operating plane
14 cutout
15 pressure cylinder
16 actuation cylinder
17 pressure cavity
18 pressure conduit
19 pressure conduit
20 pressure generator
21 reset device
22 pressure cavity
23 control device
24 operating panel
25 carrier support
26 transversal axis
27 shaft
28 rail

What is claimed is:

1. A pressure forming device for dental deep drawing applications, the pressure forming device comprising:
a housing;
a foil carrier configured to support a deep drawing foil;
at least one operating unit at least partially arranged in the housing and including
a heating device configured to heat the deep drawing foil to a deep drawing temperature;
a model carrier, configured to support a jaw model; and
a pressure device, configured to provide a pneumatic pressure,
wherein the pressure device is configured to cooperate with the deep drawing foil and the model carrier when performing a deep drawing process, so that the deep drawing foil, after performing a heating step of the deep drawing process in which the deep drawing foil heated by the heating device, is loaded with pneumatic pressure in a forming step of the deep drawing process and thus deep drawn over the jaw model supported on the model carriers,
wherein a pressure cylinder of the pressure device and the model carrier are movable towards one another along an operating axis of the operating unit, so that the pressure device is movable into indirect or direct operating engagement with the model carrier in order to perform the forming step,
wherein the heating device and the model carrier are arranged on an identical side of the deep drawing foil,
wherein the heating device and the model carrier are alternatively movable by a movement device into an operating position that is arranged along the operating axis.

2. The pressure forming device according to claim 1,
wherein the heating device and the model carrier are movable by the movement device into an operating plane, oriented perpendicular to the operating axis, and
wherein the movement device is formed by a drawer that is movable along a linear path along a movement axis.

3. The pressure forming device according to claim 1, further comprising:
a plurality of the operating units arranged in the housing,
wherein operating axes of the operating units are respectively vertically oriented and arranged parallel to one another, and
wherein the operating units are arranged horizontally adjacent to one another.

4. The pressure forming device according to claim 3,
wherein the foil carrier is configured rectangular,
wherein the foil carrier extends along all operating units and includes a number of cutouts that correspond to a number of the operating units, wherein a respective cutout is associated with a respective operating unit.

5. The pressure forming device according to claim 1,
wherein the foil carrier is configured as a drawer that is movable on a linear path between a loading position in which the foil carrier is manually loadable with the deep drawing foil and a heating position in which the deep drawing foil supported on the foil carrier is heatable by the heating device.

6. The pressure forming device according to claim 5, further comprising:
a switch, arranged to be actuated by a transfer of the foil carrier into its heating position,
wherein the switch is operatively connected with a control device that is configured to activate the heating device when the switch is actuated.

7. The pressure forming device according to claim 1,
wherein the pressure device is transferrable between an idle condition and a pressure condition,
wherein the pressure cylinder is moveable along the operating axis in a direction towards the model carrier until the pressure device is in operating engagement with the model carrier, in order to transfer the pressure device from the idle condition into the pressure condition.

8. The pressure forming device according to claim 1,
wherein the pressure cylinder is connected by a pressure conduit with a pressure generator in order to generate a pneumatic pressure, so that the pressure generator is configured to generate a positive pressure in the pressure cylinder during the forming step,
wherein the positive pressure is applicable to the deep drawing foil by the pressure cylinder, so that the deep drawing foil is pressed over the jaw model.

9. The pressure forming device according to claim 8,
wherein the pressure device includes an actuation cylinder,
wherein the pressure cylinder is supported as a piston in the actuation cylinder, wherein the actuation cylinder defines a pressure cavity with the pressure cylinder,
wherein the pressure cavity is connected by a pressure conduit with the pressure generator or another pressure generator, so that the pressure cylinder is movable along the operating axis due to a loading of the pressure cavity with the pneumatic pressure.

10. The pressure forming device according to claim 9, further comprising: a reset device, or a gas spring, configured to move the pressure cylinder back along the operating axis after completing the forming step.

11. A method for performing a deep drawing process for deep drawing a deep drawing foil over at least one jaw model using a pressure forming device, the method comprising:
loading a foil carrier with the deep drawing foil;
heating the deep drawing foil in a heating step of the deep drawing process using a heating device, so that the deep drawing foil is configured to be deep drawn over a jaw model;
after completing the heating step, moving a pressure cylinder of a pressure device and a model carrier supporting the jaw model along an operating axis towards each other, so that the pressure device and the model carrier come into indirect or direct operating engagement;
deep drawing the deep drawing foil in a forming step of the deep drawing process over the jaw model by a pneumatic pressure generated in the pressure cylinder of the pressure device; and
after completing the heating step and before performing the forming step, moving the heating device from an operating position of the heating device, where the heating device is arranged along the operating axis on one side of the deep drawing foil using a movement device and moving the model carrier into an operating position of the model carrier using the movement device, wherein the model carrier is arranged along the operating axis on the one side of the deep drawing foil in the operating position of the model carrier.

12. The method according to claim 11, wherein the movement device performs the movement of the heating device from its operating position and the movement of the model carrier into its operating position in a joint movement.

13. The method according to claim 11, wherein the heating device is activated automatically as soon as the foil carrier including the deep drawing foil arranged thereon is moved into a heating position in which the deep drawing foil is heatable by the heating device.

14. The method according to claim 11,
wherein the pressure device is automatically transferred from an idle position into a pressure position by control of the control device in order to perform the forming step,
wherein the pressure cylinder is moved towards the model carrier in order to transfer the pressure device from the idle condition into the pressure condition and a pneumatic pressure is automatically generated after indirect or direct operating engagement with the model carrier, and
wherein the pneumatic pressure is a positive pressure that is imparted upon the deep drawing foil, so that the deep drawing foil is deep drawn over the jaw model.

15. The method according to claim 14, wherein the pneumatic pressure of the pressure device is automatically released by control of the control device after a cooling period and the pressure device is automatically transferred back into its idle position.
